(19) United States
(12) Patent Application Publication
(10) Pub. No.: US 2009/0121844 A1
(43) Pub. Date: May 14, 2009

(54) SAMPLING INTERMEDIATE RADIO FREQUENCIES

(75) Inventors: Joseph P. Repke, Cary, NC (US); Thomas J. Frederick, Chapel Hill, NC (US)

Correspondence Address: FISH & RICHARDSON P.C., P.O. BOX 1022, MINNEAPOLIS, MN, 55440-1022, US

(73) Assignee: SIRIT TECHNOLOGIES INC., Toronto (CA)

(21) Appl. No.: 11/936,945

(22) Filed: Nov. 8, 2007

(51) Int. Cl. H04Q 5/22

(52) U.S. Cl. 340/10.42

(57) ABSTRACT

The present disclosure is directed to a system and method for sampling intermediate radio frequencies. In some implementations, a method for RF communication includes receiving an analog Radio Frequency (RF) signal. The analog RF signal is downconverted to an analog signal centered at an Intermediate Frequency (IF). The analog IF signal is converted to a digital signal centered at an IF. The digital IF signal is downconverted to a digital baseband signal.

### TECHNICAL FIELD

This invention relates to sampling radio frequencies and, more particularly, to the sampling intermediate radio frequencies.

### BACKGROUND

In some cases, an RFID reader operates in a dense reader environment, i.e., an area with many readers sharing fewer channels than the number of readers. Each RFID reader works to scan its interrogation zone for transponders, reading them when they are found. Because the transponder uses radar cross section (RCS) modulation to backscatter information to the readers, the RFID communications link can be very asymmetric. The readers typically transmit around 1 watt, while only about 0.1 milliwatt or less gets reflected back from the transponder. After propagation losses from the transponder to the reader the receive signal power at the reader can be 1 nanowatt for fully passive transponders, and as low as 1 picowatt for battery assisted transponders. At the same time other nearby readers also transmit 1 watt, sometimes on the same channel or nearby channels. Although the transponder backscatter signal is, in some cases, separated from the readers' transmission on a sub-carrier, the problem of filtering out unwanted adjacent reader transmissions is very difficult.

### SUMMARY

The present disclosure is directed to a system and method for sampling intermediate radio frequencies. In some implementations, a method for RF communication includes receiving an analog Radio Frequency (RF) signal. The analog RF signal is downconverted to an analog signal centered at an Intermediate Frequency (IF). The analog IF signal is converted to a digital signal centered at an IF. The digital IF signal is downconverted to a digital baseband signal.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating an example interrogation system in accordance with some implementations of the present disclosure;

FIG. 2 is a block diagram illustrating an example reader of FIG. 1 in accordance with some implementations of the present disclosure;

FIG. 3 is a block diagram illustrating an example reader of FIG. 1 in accordance with some implementations of the present disclosure;

FIG. 4 is a flow chart illustrating an example method for using intermediate frequencies in the reader of FIG. 2;

FIG. 5 is a flow chart illustrating an example method for using intermediate frequencies in the reader of FIG. 3; and

FIG. 6 is a block diagram illustrating an example transmission section of FIG. 2 in accordance with some implementations of the present disclosure.

Like reference symbols in the various drawings indicate like elements.

### DETAILED DESCRIPTION

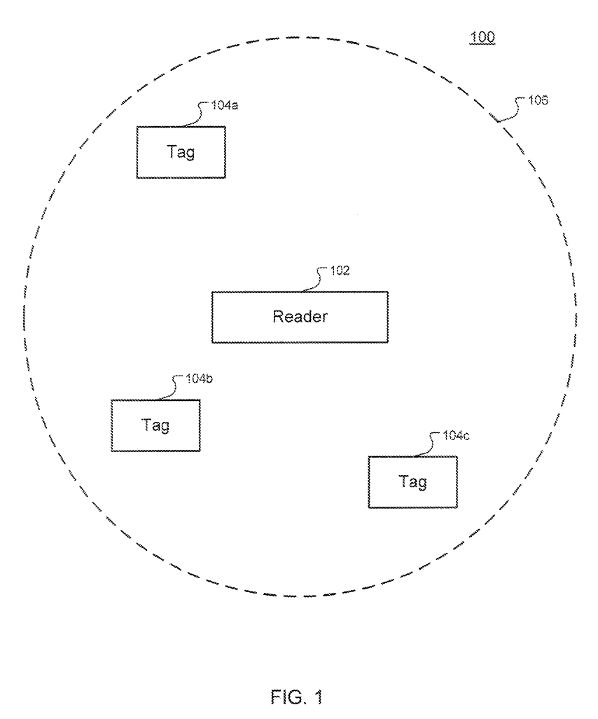

FIG. 1 is a block diagram illustrating an example system 100 for using Radio Frequency (RF) signals transmitted from an RFID reader 102 to detect the presence of RFID transponders, or tags 104a-c, located within a general area 106. At a high level, the RFID system 100 includes tags 104a-c communicably coupled with RF reader 102. The RF reader 102 may downconvert a received RF signal to an intermediate frequency (e.g., 20 MHz) and directly sample the received signal. Similarly, the RE reader 102 may directly sample a transmit signal at an intermediate frequency which is then upconverted to RF. In some examples, the RF reader 102 may downconvert a directly sampled RF signal to a digital signal with an intermediate frequency. In some implementations, the RF reader 102 can extract and/or encode information in RF signals by performing some portion of signal processing and/or signal conversion at an intermediate frequency (IF), where the IF is between zero frequency (DC) and the RF of the desired radio signal. For example, the desired radio signal may be in the range of 860 MHz to 960 MHz, and the IF may be in the range of 10 MHz to 50 MHz. In some instances, the RF reader 102 includes elements such as filters, amplifiers and/or oscillators that operate at an IF. In operating at least a portion of the RF reader 102 at an IF, the system may provide one or more of the following advantages over alternative systems: filter selectivity may be improved when operating at IF by permitting digital filter implementations or with more highly-selective analog technologies; a wider selection of amplifiers may be available when operating at IF frequencies as opposed to providing the gain at either RF frequencies or at baseband; configuration of the RF reader may be simplified and/or costs of the RF reader may be reduced when performing more signal processing at IF than is done in some other architectures.

In some implementations, the RF reader 102 includes fixed-frequency first local oscillators to generate a variable frequency IF. In this implementation, the system 100 may convert the channel frequencies to specific IFs and use a variable second local oscillator to further down-convert the IF signal to baseband prior to processing received signals. Use of fixed frequency analog oscillators allows the design of very low phase noise systems. For example, a fixed frequency RF oscillator may be designed to have 20 dB lower phase noise than a variable RF oscillator tunable over the whole band of interest.

At a high level, the system 100 includes tags 104a-c communicably coupled with RF reader 102. In some implementations, the RF reader 102 performs some portion of signal processing and/or signal conversion at an intermediate frequency (IF), which may improve performance capabilities and reduce hardware and manufacturing costs of the RF reader 102. For example, in some implementations, RF reader 102 may utilize fixed-frequency oscillators to convert between RF and IF signals. The use of fixed-frequency oscillators may, in some implementations, reduce noise in the system 100, simplify RF synthesizer designs, and/or improve synthesizer performance. For example, the RF reader 102 may substantially reduce phase noise from baseband signals because the receiver portions and transmitter portions can, in some implementations, both use the same fixed-frequency oscillator to convert between RF and variable frequency IF. In some implementations, the RF reader 102 may include only single channel analog-to-digital (A-to-D) converter (ADC) and digital-to-analog (D-to-A) converter (DAC) circuits, yielding lower cost. Channelization can, in some implementations, be done digitally, which may allow extremely fast frequency hopping (e.g., less than 100 microseconds) and/or very flexible software defined architectures. In some implementations, the RF reader 102 may operate at IFs independent of mixers. For example, the RF reader 102 may omit, or not include an RF mixer which can reduce analog circuitry which is associated with signal loss and/or noise figure reduction. In addition, the RF reader 102 may not include an RF oscillator, instead using the sample clock to convert between RF and IF which may also reduce circuitry.

The RF reader 102 includes any software, hardware, and/or firmware configured to transmit and receive RF signals using IF stages. In general, the RF reader 102 may transmit requests for information within a certain geographic area associated with reader 102. The reader 102 may transmit the query in response to a request, automatically, in response to a threshold being satisfied (e.g. expiration of time), as well as others. The interrogation zone 106 may be based on one or more parameters such as transmission power, associated protocol (i.e. set of rules for communication between RFID tags and readers), nearby impediments (e.g. objects, walls, buildings), as well as others. In general, the RF reader 102 may include a controller, a transceiver coupled to the controller, and at least one RF antenna coupled to the transceiver (not illustrated). In this example, the RF antenna transmits commands generated by the controller through the transceiver and receives responses from RFID tags 104 in the associated interrogation zone 106. In some implementations, the controller can determine statistical data based, at least in part, on tag responses. The reader 102 often includes a power supply or may obtain power from a coupled source for powering included elements and transmitting signals. In general, the reader 102 operates in one or more specific frequency bands allotted for RF communication. For example, the Federal Communication Commission (FCC) has assigned 902-928 MHz and 2400-2483.5 MHz as frequency bands for certain RFID applications. In some implementations the reader 102 may dynamically switch between different frequency bands and protocols.

In some implementations, the RF reader 102 includes one or more fixed-frequency oscillators, offset from the RF band, to convert between RFs and IFs. In some examples, the RF reader 102 includes RF mixers and a fixed-frequency oscillator used to downconvert received RF signals to variable-frequency IF signals and to upconvert variable-frequency IF transmission signals to transmit RF signals. In some examples, the RF reader 102 may include a fixed oscillator to generate sample clock signals for both ADC and DAC, which, in the case of no RF mixers, can convert signals between RFs and IFs. In this example, the RF reader 102 may use a harmonic of a sample clock used for A-to-D or D-to-A conversion to convert signals between RFs and IFs. In eliminating RF mixers, the RF reader 102 may significantly reduce the amount of circuitry.

The RFID tags 104 include any software, hardware, and/or firmware configured to respond to communication from the RFID reader 102. These tags 104 may operate without the use of an internal power supply. Rather, the tags 104 may transmit a reply to a received signal from the reader 102 using power stored from the previously received RF signals, independent of an internal power source. This mode of operation is typically referred to as backscattering. In some implementations, the tags 104 can alternate between absorbing power from signals transmitted by the reader 102 and transmitting responses to the signals using at least a portion of the absorbed power. In passive tag operation, the tags 104 typically have a maximum allowable time to maintain at least a minimum DC voltage level. In some implementations, this time duration is determined by the amount of power available from an antenna of a tag 104 minus the power consumed by the tag 104 and the size of the on-chip capacitance. The effective capacitance can, in some implementations, be configured to store sufficient power to support the internal DC voltage when there is no received RF power available via the antenna. The tag 104 may consume the stored power when information is either transmitted to the tag 104 or the tag 104 responds to the reader 102 (e.g., modulated signal on the antenna input). In transmitting responses back to the reader 102, the tags 104 may include one or more of the following: an identification string, locally stored data, tag status, internal temperature, and/or others.

In one aspect of operation, the reader 102 periodically transmits signals in the interrogation zone 106. In the event that the tag 104 is within the interrogation zone 106, the tag 104 transmits a response to the reader 102. The reader 102 receives the RF signals and converts to the RF signal to an IF signal prior to digitally processing the response. In some implementations, the RF reader 102 directly samples the analog IF signal using a sample clock signal derived from or provided by a fixed-frequency oscillator. In some implementations, the RF reader 102 directly samples the RF signal and downconverts the RF signal to an Digital IF signal using a sample clock signal from a fixed-frequency oscillator. In regards to transmitting signals in the interrogation zone 106, the reader 102 upconverts the baseband transmission signal to an IF signal. The reader 102 may upconvert the baseband signal prior to analog conversion or during analog conversions using a fixed-frequency signal.

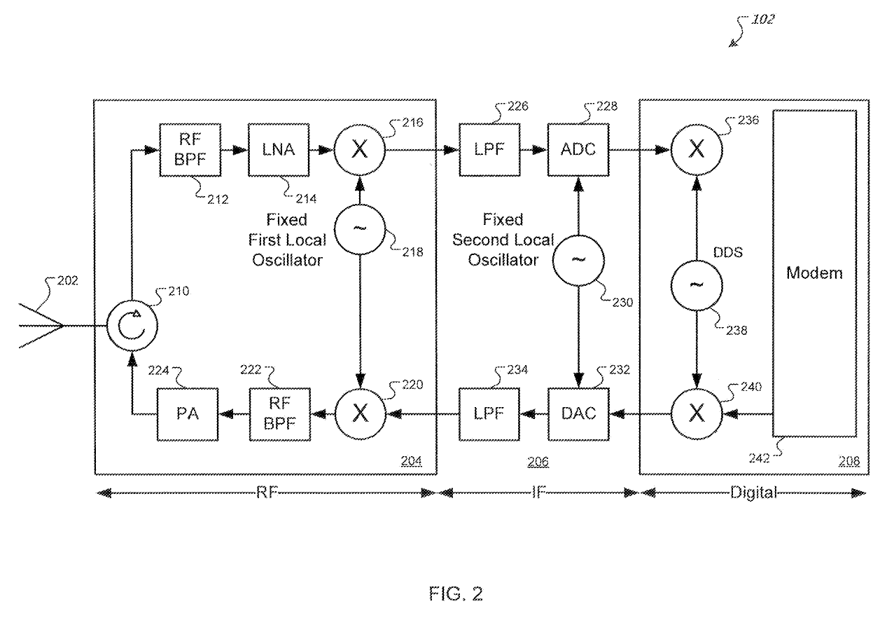

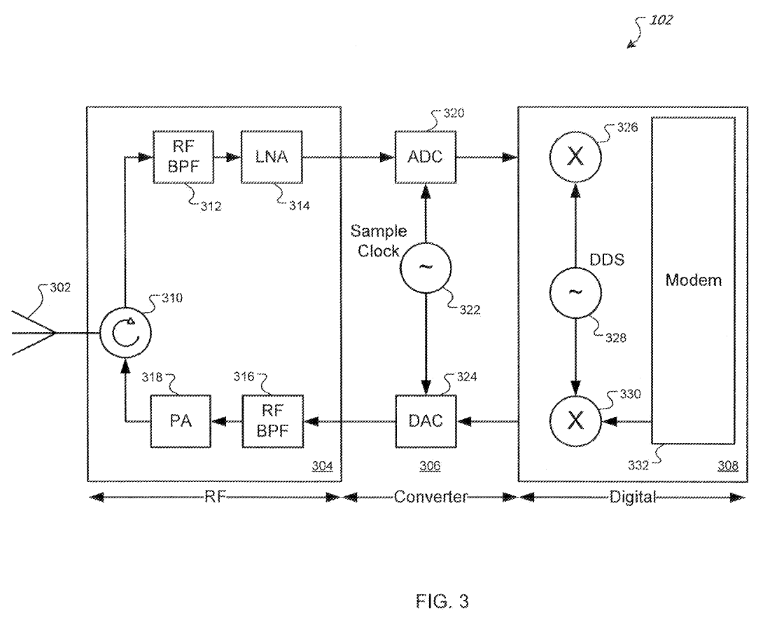

FIG. 2 illustrates an example reader 102 of FIG. 1 in accordance with some implementations of the present disclosure. In particular, the illustrated reader 102 utilizes fixed-frequency oscillators to convert between RF and variable frequency IF. In doing so, the reader 102 may directly sample IF signals prior to digital processing.

The RF reader 102 includes any software, hardware, and/or firmware configured to transmit and receive RF signals using IFs. In the illustrated implementation, the RF reader 102 includes an antenna 202, an RF component 204, an IF component 206, and a digital component 208. The RF reader 102 may include some, all, additional, or different elements without departing from the scope of this disclosure. For example, the reader 102 may include a controller, memory, capacitors, and/or other components.

The antenna 202 wirelessly receives and transmits RF signals between the tags 104 and the reader 102. For example, the antenna 202 may transmit a query for information associated with the tag 104, and the antenna 202 may receive, in response to at least the inquiry, information including an identifier.

The RF component 204 can include any software, hardware, and/or firmware configured to convert between analog RF signals and analog IF signals. For example, the RF component 204 may receive an analog RF signal from the antenna 202 and downconvert the received RF signal to an analog IF signal. In addition, the RF component 204 may receive an analog IF transmission signal from the IF component 206 and upconvert the IF transmission signal to an analog RF transmission signal. In the process of converting between RF and IF frequencies, the RF component 204 can, in some implementations, filter, amplify, mix, and/or otherwise process the signals.

In the illustrated example, the RF component 204 includes an RF circulator 210, RF bandpass filters (RF BPFs) 212 and 222, low noise amplifier (LNA) 214, power amplifier (PA) 224, and a first fixed-frequency oscillator 218. The RF circulator 210 directs incoming received RF signals from the antenna 202 to the receive path and directs outgoing RF transmission signals from the transmit path to the antenna 202. The receive path includes the RF BPF 212, the LNA 214 and the mixer 216. The RF BPF 212 passes a portion of the received signal to the LNA 214 while substantially rejecting other signals in the received path. The LNA 214 amplifies the filtered signal and passes the amplified RF signal to the mixer 216. The mixer 216 generates an analog IF signal using a reference signal generated by fixed-frequency oscillator 218 and the analog RF signal received from the LNA 214. In other words, the mixer 216 downconverts the RF signal to an analog IF signal.

In regards to transmission, the transmit path of the RF component 204 in the illustrated example includes a mixer 220 that receives an analog IF signal from the IF component. The mixer 220 mixes the IF signal with a reference frequency generated by the fixed-frequency oscillator 218 to upconvert the analog IF signal to an analog RF transmit signal. Both the mixer 216 and the mixer 220 receive a fixed-frequency signal from the single fixed-frequency oscillator 218. The mixer 220 passes the RF signal to RF BPF 222. The RF BPF 222 filters a band of the RF transmission signal and passes the RF band to the PA 224. The PA 224 amplifies the RF transmission signal and passes the amplified signal to the RF circulator 210, which directs the RF transmission signal to the antenna 202. In some implementations, the RF BPFs 212 and 224 eliminate, minimize, or otherwise reduce undesired bands of RF which may image to/from the desired RF band when the signal is mixed to and/or from the IFs.

The IF component 206 can include any software, hardware, and/or firmware configured to directly sample IF signals. For example, the IF component 206 may receive an analog IF signal from the RF component 204 and directly sample the IF signal to generate a digital IF signal. In the transmit direction, the IF component 206 may receive a IF signal from the digital component 208 and directly sample the digital IF signal to generate an analog IF signal. In the process of converting between analog and digital IF signals, the IF component 206 may filter, amplify, mix, and/or otherwise process the IF signals. In the illustrated implementation, IF component 206 includes low pass filters (LPFs) 226 and 234, ADC 228, DAC 232, and a second fixed-frequency oscillator 230. In the receive path, LPF 226 receives the analog IF signal from the mixer 216 and attenuates frequencies higher than a cutoff frequency from the analog IF signal. The LPF 226 passes the filtered IF signal to the ADC 228 for converting to a digital IF signal. The ADC 228 receives a sample clock signal from the second fixed-frequency oscillator 230 and directly samples the analog IF signal to generate a digital IF signal. In the transmit path, DAC 232 receives a digital IF transmission signal from the digital component 208 and a sample clock signal from the fixed-frequency oscillator 230. The DAC 232 directly samples the digital IF signal in accordance with the fixed-frequency signal and generates an analog IF signal. The ADC 228 and DAC 232 use a sample clock signal generated from a single fixed-frequency oscillator 230. The DAC 232 passes the analog IF signal to the LPF 234. The LPF 234 attenuates frequencies above a cutoff frequency and passes the filtered IF signal to the mixer 220. In some implementations, the LPF 226 performs anti-aliasing filtering of the analog IF signal to ADC 228. In some implementations, the LPF 234 performs anti-imaging filtering of the analog IF signal. The LPF 226 and/or LPF 234 can, in some implementations, have wide transition bands, which may reduce cost of manufacturing the reader 102.

The digital component 208 can include any software, hardware, and/or firmware configured to digitally processes signals. In the illustrated implementation, the digital component 208 includes a first mixer 236, a second mixer 240, a direct digital synthesizer (DDS) 238, and a modem 242. The first mixer 236 receives the digital IF signal from the ADC 228 and a digital local oscillator signal from the DDS 238 and downconverts the digital IF signal to baseband. In some implementations, the DDS 238 can vary the frequency of the local oscillator signal to downconvert to baseband. The RF reader 102 uses the DDS frequency to select which RF frequency is processed at baseband. The modem 242 digitally processes the received baseband signal and/or generates commands encoded in baseband. The second mixer 240 receives a digital baseband signal from the modem 242 and the digital local oscillator signal from the DDS 238 and upconverts the baseband signal to a digital IF signal. In the illustrated implementation, the first mixer 236 and the second mixer 240 receive mixing signals from a single DDS 238. In some implementations, channelization can be done digitally, which may allow fast frequency-hopping, flexible software-defined architectures and/or the easy addition of protocols by changing digital filters.

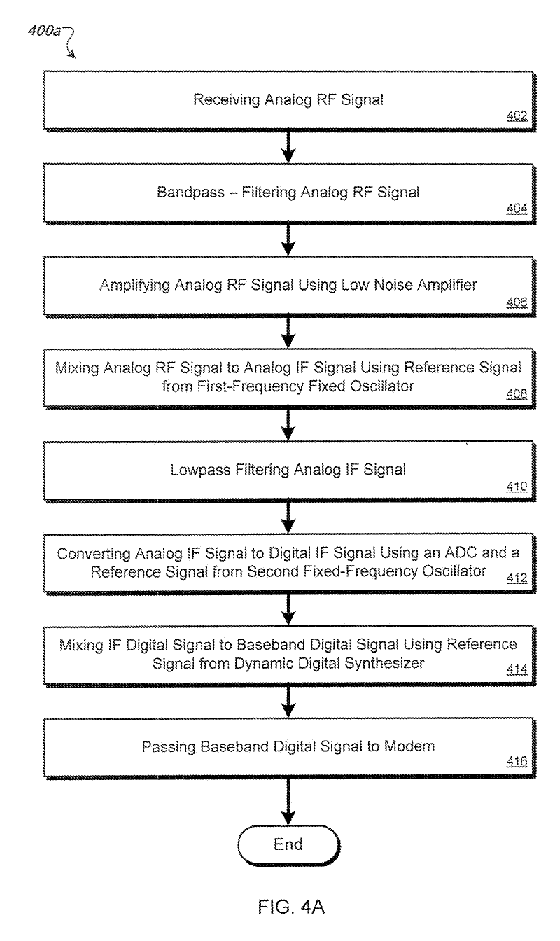

FIG. 3 illustrates an example reader 102 of FIG. 1 in accordance with some implementations of the present disclosure. In particular, the illustrated reader 102 directly samples the received RF signals independent of RF mixers. In other words, the mixerless implementation may convert between analog RF signals and digital IF signals without the use of RF mixers. In some implementations, a harmonic of the sample clock used for A-to-D and D-to-A signal conversion is used as an RF oscillator to and/or from a digital IF signal. The illustrated implementation may reduce the number of oscillators and/or mixers included in the RF reader 102, which may simplify the circuitry and/or reduce manufacturing, costs.

The RF reader 102 includes any software, hardware, and/or firmware configured to transmit and receive RF signals using IFs. In the illustrated implementation, the RF reader 102 includes an antenna 302, an RF component 304, a converter component 306, and a digital component 308. The RF reader 102 may include some, all, additional, or different elements without departing from the scope of this disclosure. For example, the reader 102 may include a controller, memory, capacitors, and/or other components. The antenna 302 wirelessly receives RF signals from the tags 104 and wirelessly transmits RF signals to the tags 104. For example, the antenna 302 may transmit a query for information associated with the tag 104, and the antenna 302 may receive, in response to at least the inquiry, information including an identifier.

The RF component 304 can include any software, hardware, and/or firmware that filters and/or amplifies receive and transmit RF signals. For example, the RF component 304 may receive an RF signal from the antenna 302 and filter a band of the received RF signal. In some implementations, the RF component 304 may amplify the filtered band prior to passing the RF signal to the converter component 306. In addition, the RF component 304 may receive an RF transmission signal from the converter component 306 and filter a band of the RF transmission signal. In some implementations, the RF component 304 can amplify the RF transmission signal prior to passing the signal to the antenna 302. In the illustrated implementation, the RF component 304 includes an RF circulator 310, RF BPFs 312 and 316, LNA 314 and PA 318. The RF circulator 310 directs incoming received RF signals from the antenna 302 to the receive path and directs outgoing RF transmission signals from the transmit path to the antenna. The receive path of the RF component includes the RF BPF 312 and the LNA 314. The RF BPF 312 filters out a band of the received RF signal and passes the filtered RF signal to the LNA 314. The LNA 314 amplifies the RF signal and passes the RF signal to the converter component 306. The transmit path of the RF component 304 includes the RF BPF 316 and the PA 318. The RF BPF 316 receives an RF transmission signal from the converter component 306 and filters out a band of the RF transmission signal. The RF BPF 316 passes the RF transmission signal to the PA 318. The PA 318 amplifies the RF transmission signal and passes the RF transmission signal to the circulator 310. The RF BPFs 312 and 316, in some implementations, eliminate undesired bands of RF which may image onto the desired RF band when the signal is converted to and/or from the IF signal.

The converter component 306 can include any software, hardware, and/or firmware configure to convert between analog RF signals and digital IF signals. For example, the converter component 306 may receive an analog RF signal from the RF component 304 and downconvert the RF signal to a digital IF signal prior to passing the signal to the digital component. In addition, the converter component 306 may receive a digital IF signal from the digital component 308 and upconvert the IF signal to an analog RF signal. In the illustrated implementation, the converter component 306 includes an ADC 320, a DAC 324, and a fixed-frequency oscillator 322. In the receive path, the ADC 320 receives an analog RF signal from the RF component 304 and a sample clock signal from the fixed-frequency oscillator 322 and directly samples the analog RF signal in accordance with the fixed-frequency signal. Due to mixing that may occur during sampling, the ADC 320 generates a digital IF signal based, at least in part, on the analog RF signal. In the transmit path of the converter component 306, the DAC 324 receives a digital IF signal from the digital component 308 and a fixed-frequency signal from the oscillator 322 and directly samples the digital IF signal in accordance with the fixed-frequency signal. Due to mixing that may occur during sampling, the DAC 324 upconverts the digital IF signal to an analog RF signal. In some implementations, the fixed-frequency signal is based, at least in part, on a high frequency basis function. The primary output of DAC 324 may be outside of the Nyquist range. That is to say that the frequency of the output signal from DAC 324 may be outside of the range from 0 Hz to one half the sampling rate, F_{S}/2. In some implementations, DAC 324 produces a higher frequency output by using a higher frequency basis function. For example, if instead of a low frequency basis function, an RF band pulse consisting of L cycles of a sinusoid is used, then the output frequency from the DAC will be centered around L·F_{S} instead. As an example, consider a case where sample clock 322 operates at a frequency of 125 MHz. Furthermore, if the RF DAC 324 uses L=7, then the output frequency of the RF DAC 324 will, in this example, be principally centered around 875 MHz, with an RF Nyquist range of L·F_{S}−F_{S}/2=812.5 MHz to L·F_{S}+F_{S}/2=937.5 MHz.

In the illustrated implementation, digital component 308 can include any software, hardware, and/or firmware configured to digitally process received signals and/or generate digital commands. In the illustrated implementation, the digital component 308 includes a first mixer 326, a second mixer 330, a DDS 328, and a modem 332. The first mixer 326 receives digital IF signals from the ADC 320 and a signal from the DDS and downconvert the IF signal to baseband signals. The frequency of the signal of the DDS 328 may be varied depending on the IF in order to generate a baseband signal. The first mixer passes the baseband signal to the modem 332 for processing. The second mixer 330 receives digital baseband signals from the modem 332 and a signal from the DDS 328 and upconverts the digital baseband signal to a digital IF signal. In some implementations, channelization can be done digitally, which may allow fast frequency hopping, flexible software defined architectures and/or the easy addition of protocols by changing digital filters.

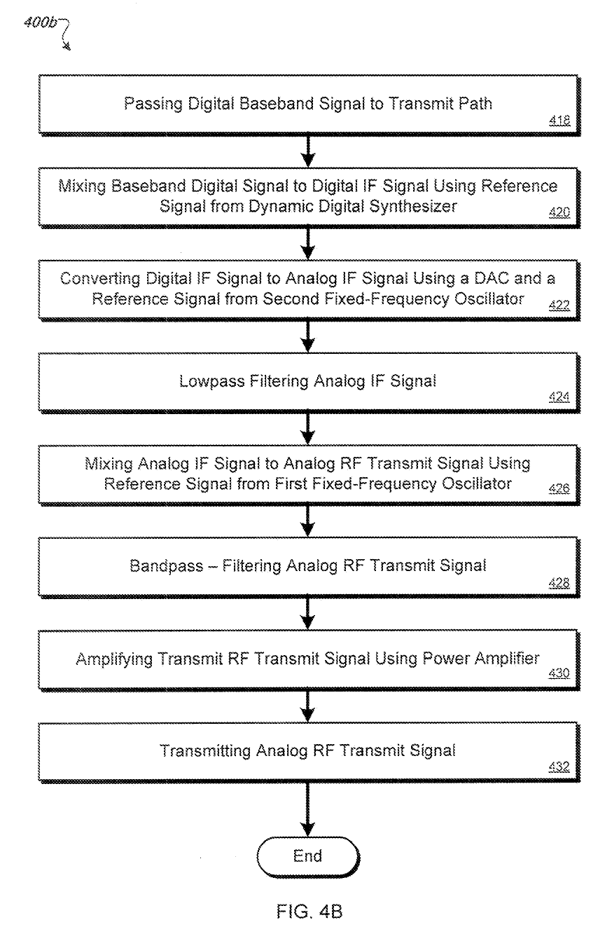

FIG. 4 is a flowchart illustrating example methods 400a and 400b for managing an RF reader 102 of FIG. 2. Generally, the methods 400a and 400b respectively describe example techniques for utilizing the superheterodyne radio concept to receive and transmit information in an RF signal. In particular, the methods 400a and 400b describe techniques where a first fixed-frequency oscillator is used to convert between analog RF and IF signals and a second fixed-frequency oscillator is used as a sample clock for converting between digital and analog IF signals. The reader 102 may use any appropriate combination and arrangement of logical elements implementing some or all of the described functionality.

Method 400a begins at step 402 where an RF signal is received. For example, the antenna 202 may receive an RF signal from a tag 104. At step 404, a frequency band is selected from the analog RF receive signal using an RF BPF. Next, at step 406, the filtered analog RF receive signal is amplified using an LNA. At step 408, the analog RF receive signal is mixed to a variable frequency analog IF receive signal using a first fixed-frequency oscillator as a reference signal. Next, at step 410, the portion of the analog IF receive signal above a threshold frequency is significantly attenuated by an LPF. At step 412, the analog IF receive signal is converted to a digital IF receive signal using an ADC and a reference signal generated by a second fixed-frequency oscillator. The digital IF receive signal is then mixed to baseband frequency using a reference signal from a direct digital synthesizer in step 414. Finally in step 416, the digital baseband receive signal is passed to the modem.

Method 400b begins at step 418 where a digital baseband signal is passed to the transmit path of the RF reader 102 of FIG. 3. In step 420, the digital baseband signal is mixed to an IF signal using a reference signal from a direct digital synthesizer. Next, the digital IF signal is converted to an analog IF signal using a reference signal from the second fixed-frequency oscillator in step 422. In step 424, the portion of the analog IF transmit signal above a threshold frequency is significantly attenuated by an LPF. Next, the analog IF transmit signal is mixed to an analog RF transmit signal using a reference signal from the first fixed-frequency oscillator in step 426. In step 428, a frequency hand is selected from the analog RF transmit signal using an RF BPF. In step 430, the analog RF transmit signal is amplified by a PA. Finally in step 432, the analog RF transmit signal is transmitted by an antenna.

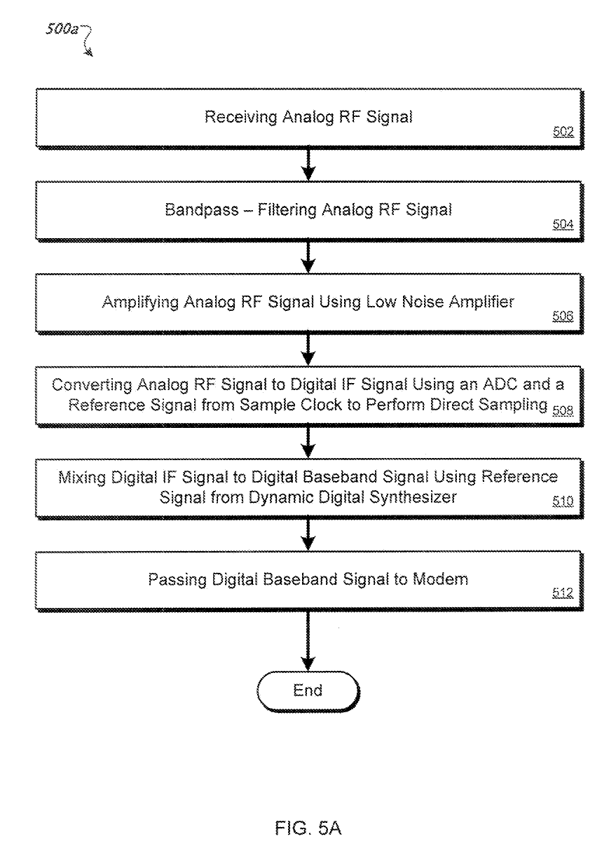

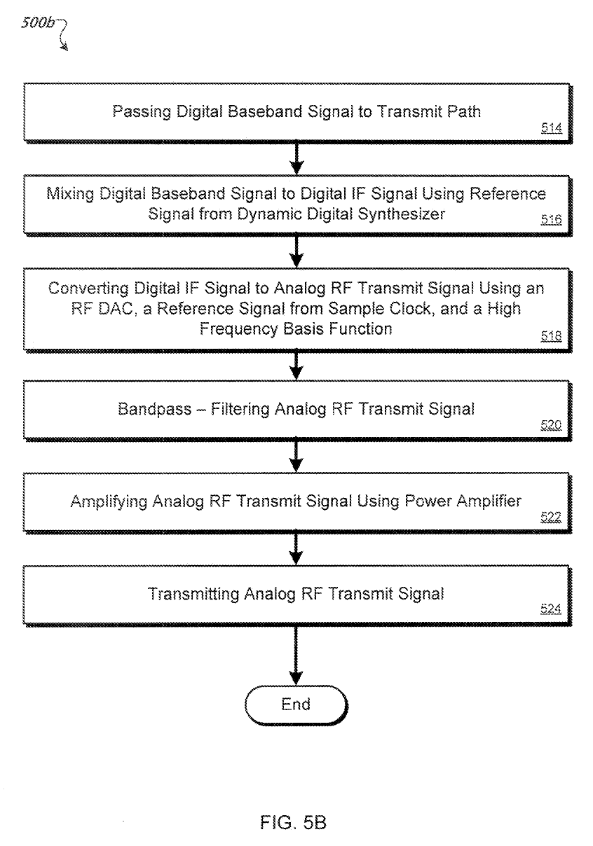

FIG. 5 is a flowchart illustrating example methods 500a and 500b for managing an RF reader 102 of FIG. 3. Generally, the methods 500a and 500b respectively describe example techniques for utilizing the superheterodyne radio concept to receive and transmit information in an RF signal. In particular, the methods 500a and 500b describe techniques where a sample clock is used for converting between digital and analog signals and a harmonic of the same sample clock is used as an oscillator for converting IF signals to RF signals. The reader 102 may use any appropriate combination and arrangement of logical elements implementing some or all of the described functionality.

Method 500a begins at step 502 where an RF signal is received. For example, the antenna 202 may receive an RF signal from a tag 104. Next in step 504, a frequency band is selected from the analog RF receive signal. Then in step 506, the analog RF receive signal is amplified in an LNA. The analog RF receive signal is then converted to a digital IF receive signal using an ADC and a sample clock to perform direct sampling in step 508. In step 510, the digital IF receive signal is mixed to a digital baseband receive signal using a reference signal generated by a direct digital synthesizer (DDS). Finally in step 512, the digital baseband receive signal is passed to a modem.

Method 500b begins at step 514, where a digital baseband signal is passed to the transmit path of reader 102 of FIG. 3. Next in step 516, the digital baseband signal is mixed to a digital IF signal using a reference signal generated by a direct digital synthesizer. The digital IF signal is then converted to an analog RF transmit signal using a DAC, a reference signal from a sample clock, and a high frequency basis function in step 518. In step 520, a frequency band of the analog RF transmit signal is selected by an RF BPF. Then in step 522 the analog RF transmit signal is amplified by a PA. Finally in step 524 the analog RF transmit signal is transmitted by an antenna.

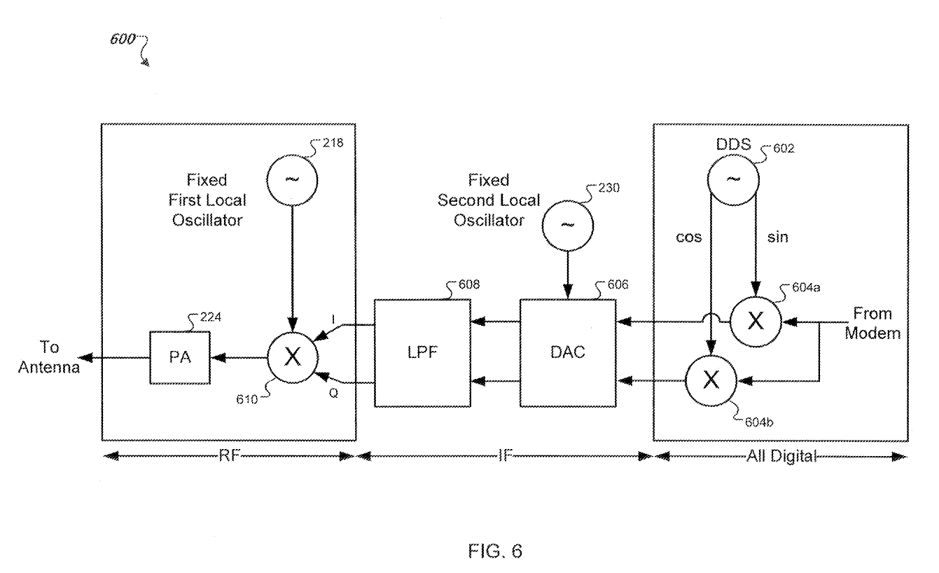

FIG. 6 is a block diagram illustrating an example transmission section 600 of the RFID reader 102 of FIG. 2. In particular, the transmission section 600 transmits RF signals using an intermediate frequency. In some implementations, the transmission section 600 includes an in-phase and quadrature components (I and Q) in the transmission path. In this case, the transmission section 600 can transmit RF signals using intermediate frequencies independent of RF BPF 222. By using phase quadrature intermediate frequency components and a quadrature RF mixer the image frequency is substantially eliminated and the RF BPF 222 may not be required.

In the illustrated implementation, the digital portion of the transmission section 600 includes a DDS 602 and mixers 604a and 604b. The DDS 602 generates an in-phase and quadrature components and passes the components to the mixers 604a and 604b, respectively. The mixers 604a and 604b also receive digital signals from the modem 242 and mix the digital signals with the in-phase and quadrature components to generate intermediate-frequency components. In regards to the intermediate-frequency portion, the transmission section includes DAC 606 and LPF 608. The DAC 606 converts the digitals signals to analog in-phase and quadrature components and passes the components to the LPF 608. The LPF 608 attenuates frequencies above a cutoff frequency for both the in-phase and quadrature components and passes the components to the RF portion. The RF portion includes the mixer 610 and the PA 224. The mixer 610 mixes the fixed-frequency signal from oscillator 618 and the in-phase and quadrature intermediate-frequency components and generates the RE signal for transmission. The PA 224 amplifies the RF transmission signal and passes the signal to the antenna for transmission. In some implementations, the section 600 can be an image reject transmit scheme which, if the I/Q are substantially balanced, can operate independent of an RF band pass filter.

A number of embodiments of the invention have been described. Nevertheless, it will be understood that various modifications may be made without departing from the spirit and scope of the invention. Accordingly, other embodiments are within the scope of the following claims.

What is claimed is:

1. A Radio Frequency Identifier (RFID) reader, comprising:
an antenna configured to receive an analog Radio Frequency (RF) signal;
an RF component configured to downconvert the analog RF signal to an analog signal centered at an Intermediate Frequency (IF);
an IF component configured to convert the analog IF signal to a digital signal centered at an IF; and
a digital component configured to downconvert the digital IF signal to a digital baseband signal.

2. The RFID reader of claim 1, wherein the RF component comprises:
a fixed oscillator configured to generate a signal at a substantially fixed frequency; and
a mixer configured to downconvert the RF signal to the analog IF signal using the fixed-frequency signal.

3. The RFID reader of claim 2, further comprising a mixer for upconverting an analog IF transmission signal to an analog RF signal using the fixed-frequency signal.

4. The RFID reader of claim 1, wherein the IF component comprises:
a fixed oscillator configured to generate a signal at a substantially fixed frequency; and
an Analog-to-Digital Converter (ADC) configured to directly sample the analog IF signal to generate the digital IF signal.

5. The RFID reader of claim 4, wherein the IF component further comprises an Digital-to-Analog Converter (DAC) configured to directly sample an digital IF transmission signal using the fixed-frequency signal to generate an analog IF transmission signal.

6. The RFID reader of claim 1, wherein the digital component comprises:
a direct digital synthesizer (DDS) configured to generate a signal centered at a plurality of frequencies; and
a mixer configured to downconvert the digital IF signal to the digital baseband signal using the DDS signal.

7. The RFID reader of claim 6, wherein the mixer comprises a first mixer, the digital component further comprising a second mixer configured to upconvert a digital baseband transmission signal to an digital IF transmission signal using the DDS signal.

8. The RFID reader of claim 1, the digital component further comprising a digital processor configured to substantially remove phase noise in the digital baseband signal.

9. The RFID reader of claim 1, wherein the digital component is further configured to generate a digital in-phase and quadrature transmission components centered at an intermediate frequency; the IF component further configured to convert the digital IF in-phase and quadrature transmission components to an analog IF in-phase and quadrature components; and the RF component further configured to convert the analog IF in-phase and quadrature components to an analog RF transmission signal and transmit the RF transmission signal independent of a BPF.

10. The RFID reader of claim 1, wherein the IF component uses a first frequency oscillator to convert the digital IF in-phase and quadrature transmission components to an IF in-phase and quadrature analog components; the RF component uses a second fixed frequency oscillator to convert the Analog IF in-phase and quadrature components to an Analog RF transmission signal.

11. A method for RF communication, comprising:
receiving an analog Radio Frequency (RF) signal;
downconverting the analog RF signal to an analog signal centered at an Intermediate Frequency (IF);
converting the analog IF signal to a digital signal centered at an IF; and
downconverting the digital IF signal to a digital baseband signal.

12. The method of claim 11, further comprising:
generating a signal at a substantially fixed frequency; and
mixing the fixed-frequency signal and the RF signal to downconvert the RF signal to the analog IF signal using the fixed-frequency signal.

13. The method of claim 12, further comprising upconverting an analog IF transmission signal to an analog RF signal using the fixed-frequency signal.

14. The method of claim 11, further comprising:
generating a signal at a substantially fixed frequency; and
directly sampling the analog IF signal to generate the digital IF signal.

15. The method of claim 14, further comprising directly sampling a digital IF transmission signal using the fixed-frequency signal to generate an analog IF transmission signal.

16. The method of claim 11, further comprising:
generating a signal centered at a plurality of frequencies; and
mixing the generated signal with the digital IF signal to downconvert the digital IF signal to the digital baseband signal.

17. The method of claim 16, further comprising mixing the generated signal with a digital baseband transmission signal to upconvert a digital baseband transmission signal to a digital IF transmission signal.

18. The method of claim 11, further comprising substantially removing phase noise in the digital baseband signal.

19. The method of claim 11, further comprising:
generating a digital in-phase and quadrature transmission components centered at an intermediate frequency;
converting the digital IF in-phase and quadrature transmission components to an analog IF in-phase and quadrature components;
converting the analog IF in-phase and quadrature components to an analog RF transmission signal; and
transmitting the RF transmission signal independent of a BPF.

20. The method of claim 11, wherein the digital IF in-phase and quadrature transmission components are converted to an IF analog in-phase and quadrature components using a first fixed-frequency oscillator, the analog IF in-phase and quadrature components are converted to an analog RF transmission signal using a second fixed-frequency oscillator.
